(19) United States
(12) Patent Application Publication
(10) Pub. No.: US 2003/0160985 A1
(43) Pub. Date: Aug. 28, 2003

(54) Evaluating the overprint characteristics of a prepress workflow

(76) Inventor: Martin Bailey, Cambridge (GB)

Correspondence Address: DARBY & DARBY P.C., P. O. BOX 5257, NEW YORK, NY, 10150-5257, US

(21) Appl. No.: 10/371,758

(22) Filed: Feb. 21, 2003

Related U.S. Application Data
(60) Provisional application No. 60/360,076, filed on Feb. 25, 2002.

(51) Int. Cl. H04N 1/60

(52) U.S. Cl. 358/1.9; 358/504; 358/518

(57) ABSTRACT

The disclosed method allows a viewer quickly and easily to evaluate the overprinting characteristics of a prepress workflow against a predefined specification. One or more test patches are printed or displayed. Each resulting test patch identifies whether the workflow in question has achieved the correct result without requiring comparison with a separately prepared sample of the correct output.

This application claims priority from U.S. Provisional Application Serial No. 60/360,076, filed Feb. 25, 2002.

### FIELD OF THE INVENTION

This invention relates to the field of computer graphics and more particularly to pre-press workflows.

### BACKGROUND

Color printing is usually carried out by producing four or more printing plates, one for each of the semi-transparent inks, or colorants, used on the printing press, typically cyan, magenta, yellow and black. As is well known in the art, all colors are determined by the values for each colorant in the appropriate palette.

To reproduce, say, a cyan circle on a square magenta ground, the magenta plate must cause no magenta ink to be applied in the area of the circle. Therefore, the magenta plate shows a square with a hole in it where the circle intersects with the square (as shown in FIG. 1). The hole is called a ‘knock out’.

In contrast, there are some circumstances where it is desirable that the colorants arising from one object do not knock out, but instead ‘overprint’ the colorants not shared with underlying objects. In the above example, if the cyan circle is overprinted, the area of intersection will appear in blue, the result of the visual mixing of cyan and magenta. This is shown in FIG. 2.

This technique is used for several purposes. Special effects may be difficult to achieve using distinct opaque graphic shapes. ‘Traps’ are often needed around the edges of objects to avoid artifacts such as white slivers appearing due to misregistration in the printing process. This is especially true for small black text characters printed on a colored ground. Sometimes a designer uses overprinting simply for convenience.

When a single piece of work is to be printed at a number of locations, and often by a number of different companies employing different workflow tools, it is important to ensure that the same printed result is achieved at all of those locations. One of the primary causes of differences in printed results is the use of features in those workflow tools that allow overprinting to be controlled in non-standard ways.

In a closed environment when the design and printing of each piece are entirely under the control of a single company, or where two companies have established reliable common working practices, such features can provide great value and flexibility. In other situations, such as the supply of a single advertisement as a digital file to a large number of publishers for inclusion in a variety of magazines, the variation introduced by their use is usually unacceptable.

Recent work in ANSI/CGATS (American National Standards Institute) and in ISO (International Standards Organization) has established widely accepted standards for correct overprinting in such broadcast workflows. However, it remains a difficult task for each publisher, prepress company or printer to ensure that their workflow produces results in accord with those standards.

Several organizations have attempted to create digitally encoded test pages that may be processed through a prepress workflow. The printed output of these test pages must be compared against a sample that is known to be correct. In almost all cases the test pages are quite large and complex. Furthermore, some of the differences between correct and incorrect output can be quite subtle.

It is therefore difficult, even for an expert, to establish quickly whether the result from a particular prepress workflow is correct or not. Yet further, the requirement for a physical sample that is known to be correct for comparison also causes problems for the easy distribution of such test kits.

In contrast, the present method provides an immediately obvious effect when output is incorrect, in a manner analagous to a color blindness test.

### SUMMARY OF THE INVENTION

The present invention involves test patches and a method for evaluating overprint characteristics of prepress workflow using test patches. A test patch is formed by the combination of at least one layer and at least one shape according to printing instructions applicable for raster image processing. The instructions are composed such that the resulting test patch will have a visual effect indicating whether the raster image processing performed correctly. For example, the instructions may be such that if the patch is correctly rasterized, the patch will appear in a solid color and if the patch is incorrectly rasterized, a shape will appear within the patch.

The following describes some test patches of the present invention:

A test patch generated by the combination of a colored shape in which at least one first colorant has a non-zero value and at least one second colorant has a zero value; and a colored layer in which the at least one first colorant has a zero value and the at least one second colorant has a non-zero value; the test patch is formed in response to the instruction that the colored layer knockout the colored shape.

A test patch generated by the combination of a first colored layer in which at least one colorant has a zero value; a second colored layer in which the at least one colorant has a non-zero value; and a colored shape in which each colorant of the shape is the same as the colorant of the first layer if the colorant in the first layer is non-zero and the same as the colorant of the second layer if the colorant in the first layer is zero. The test patch is formed in response to an instruction for the colored shape to print on (overprint or knockout) the first colored layer and the first colored layer to overprint the second colored layer.

A test patch generated by the combination of a white shape and a colored layer in response to any instruction for the shape to overprint the layer.

In a further aspect of the invention, one or more canonical patches are printed or displayed in a manner associated with the test patches so that the test patches may also be evaluated by comparison with the corresponding canonical patches.

### BRIEF DESCRIPTION OF THE DRAWINGS

FIG. 1 illustrates how the color of a shape can be reproduced when printed on a colored ground, by forming a knock out.

FIG. 2 shows the effect when overprinting of the shape in FIG. 1 is requested instead.

FIG. 3 shows a rendition of a test page in accordance with the present invention that has been reproduced matching the criteria for which the test was constructed.

FIG. 4 shows a rendition of the same test page as FIG. 2 but where the reproduction has not achieved a match in all of several tested criteria.

FIG. 5 shows a further rendition which fails to match the tested criteria on only one respect.

FIG. 6 shows the way in which the first patch in the left column of the preferred test page is constructed.

FIG. 7 shows the way in which the second and fourth patches in the left column of the preferred test page are constructed.

FIG. 8 shows the way in which the third patch in the left column of the preferred test page is constructed.

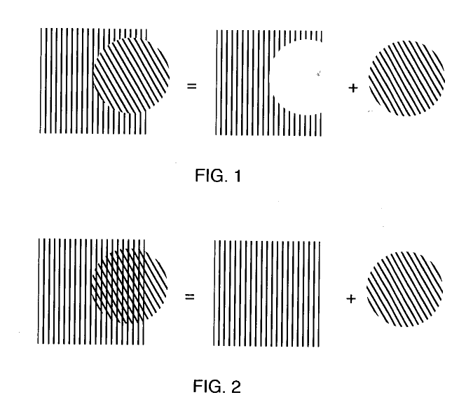

### DETAILED DESCRIPTION OF THE PREFERRED EMBODIMENT

In the preferred embodiment the test patches are generated within a test page to evaluate the effectiveness of the prepress workflow. In this embodiment the test page is expressed electronically in a page description language. The page description language is preferably the POSTSCRIPT language. PostScript is a registered trademark of Adobe Systems Inc. The page may also be expressed as an Encapsulated PostScript (EPS), the Portable Document Format (PDF) or other page description language.

The test page is processed according to a prepress workflow process, such as a raster image processor, and then produced. Typically the page is printed on paper. However, the page may be otherwise produced, such as displaying on a computer screen.

The test page includes specific constructions of one or more test patches designed to test the prepress workflow, described in detail below. The term patch is used here to generically refer to an area that represents an instance of the test or simulation of the test. Different patches are used to test different mechanism for overprinting which can be encountered in real pages encoded in a number of page description languages. When the page is produced, the resulting patches will provide a visual indication of whether the prepress workflow process, specifically the rasterization, operated correctly.

The construction of the patches exploits the deficient ways in which raster image processors will produce these patches when they do not meet the specification under test. This is achieved, according to the nature of the test, for example, by attempting to overlay the shape with the patch background or by making it the same color as the background so the viewer does not see it when processed correctly. In contrast, when the raster image processor fails to interpret the overprinting characteristics being tested, it will fail to cover over the shape, or will produce the shape or patch in a different color, thereby revealing the shape and perhaps changing the background color.

In another embodiment of the invention, the test page also includes simulated or canonical patches. The simulated patches are defined by the colorant values that would result if the test patch was processed correctly. These patches simulate the intended effect according to the specification being tested in such a way that the result obtained does not rely on the characteristics under test. In this embodiment, the test patches and corresponding canonical patches are produced using features of the page description language such that if the raster image processor with which the test page is printed performs according to the specification the patches will appear the same as the corresponding simulated correct patches. But if the raster image processor does not perform according to the part of the specification that a patch is testing, it will instead appear different, e.g., with a message apparently superimposed on it or in a different color, which alerts the user to the failure to match the specification.

By producing these patches, a separate correctly printed comparison sheet is not required. Correct patches (whether simulated or not) are produced in such a way that the appearance does not alarm the user, for example, as solid colored patch.

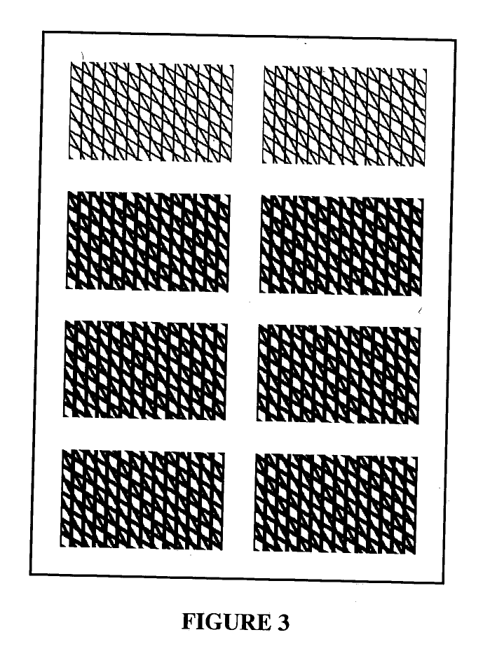

The test page rendered by a non-conforming system will be visibly different from the page produced by a conforming system. For example, FIG. 3 shows the output for the preferred test page from a prepress system that matches the criteria for which this particular test was constructed. The patches in the left hand column show the result obtained on the system under test. Those in the right hand column, reproduced on the same system at the same time, show a simulation of the result that would be obtained on a system where the overprinting criteria are matched.

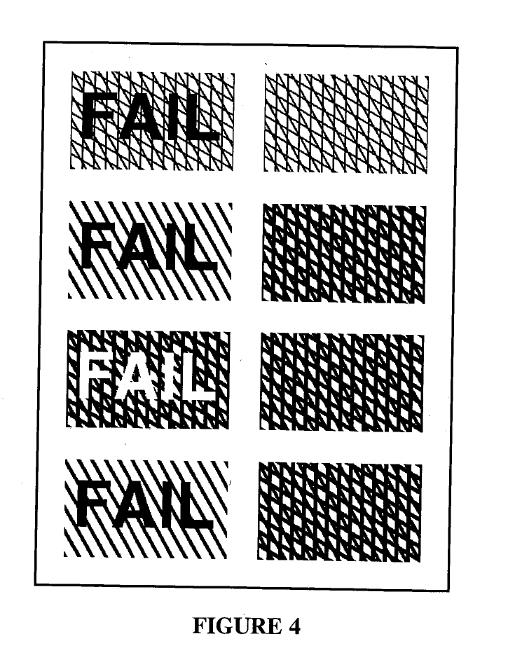

FIG. 4 shows the output for the preferred test page from a prepress system where all of the criteria under test have failed to match. The same page has produced different results from that in FIG. 3. Again the patches in the left-hand column show the result obtained on the system under test. Those in the right-hand column, reproduced on the same system at the same time, show the result that would be obtained on a system where the overprinting criteria are matched.

In this example, there are two visual indications of the systems' non-compliance with the selected criteria: the color of the adjacent pairs of patches are different; and the display of the word “FAIL” (or some other suitable word or symbol).

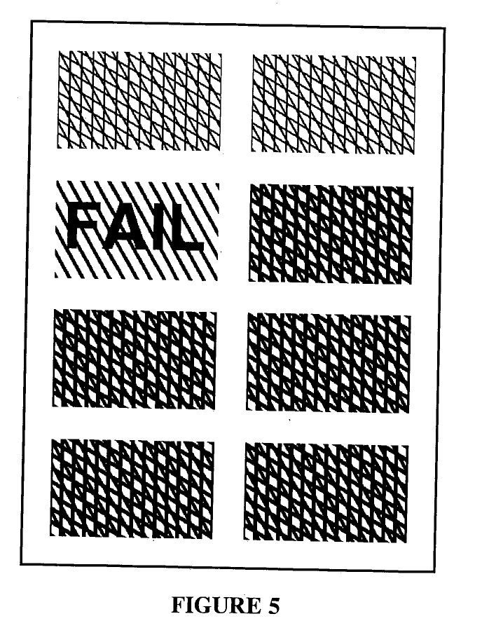

FIG. 5 shows an example where various patches were produced and only some patches indicate non-compliance. On another system, the same test page produced yet another result; this time different from that desired in only one respect; indicated by the second patch in the left-hand column.

Analysis of which patches fail in conjunction with the user manual for the system in question may lead to identification of the corrective action required in order to ensure that the system conforms, if such action is possible. There are many parameters that are set for testing or using raster image processing. The shape used in the test may be associated with those settings. In this way, if the test fails, the shape that appears will indicate the cause and/or corrective action required. In general the shape used in forming the patch may be selected based on the feature of raster image processing that is being tested.

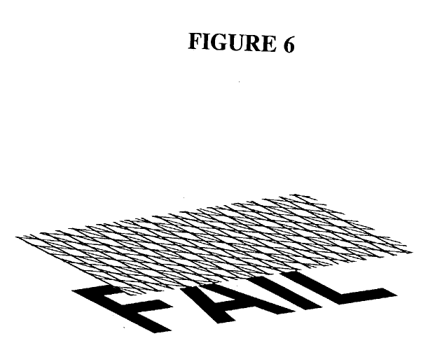

FIGS. 6-8 show the construction of the test patches illustrated in FIGS. 3-5. In the page description language, the various objects are defined (or described), at least, by their area and the color. To test overprinting various defined objects overlap in area. The terms layer and shape are used here generically to indicate objects. Layer refers generally to areas with a solid coloration and shape refers generally to text, symbol or other objects.

FIG. 6 illustrates the construction of the first patch in the left column of the test page. The test patch is composed of a colored layer set to knock out a different colored shape. The colorants of the shape and layer have the following specification: at least one colorant is zero in the layer and non-zero in the shape and at least one other colorant is zero in the shape and non-zero in the layer. Here, the layer is gray formed by a mixture of cyan, magenta and yellow. The shape is the text “FAIL” in black. The gray layer should knock out the black text printed before (that is, underneath) it. A failure to knock out will result in the word “FAIL” being visible on the gray-like background.

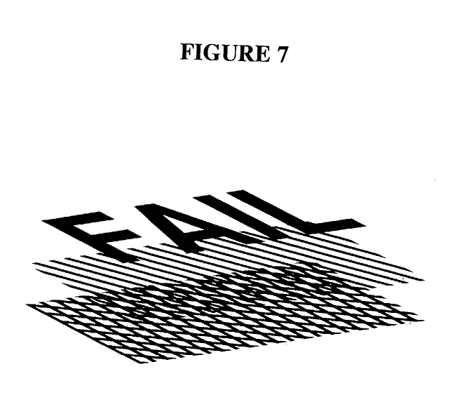

FIG. 7 illustrates the construction of the second patch in the first column. The test patch is composed of a colored shape set to print on a colored layer which is set to overprint another colored layer. The colorants of the shape and layers have the following specifications: at least one colorant is zero in the first layer and non-zero in the second layer; and each colorant of the shape is the same as the colorant of the first layer if the colorant of the first layer is non-zero and is the same as the colorant of the second layer if the colorant of the first layer is zero. Here one layer is tinted magenta and the other layer is tinted green (cyan and yellow). The shape is the text “FAIL” tinted gray. The magenta layer should overprint the green layer producing a composite color which will appear gray-like. The text in the same tint of gray is then printed over that composite. If the magenta knocks out of the green rather than overprinting the word “FAIL” will appear in gray on a magenta background.

The fourth left-hand patch differs from the second patch only in the way the colors are expressed in the page description language. In one case, the colors are expressed using the PostScript language setcmykcolor operator (or its PDF equivalent) where zero valued colorants are generally expected to overprint when overprinting is turned on. In the other case, the colors are expressed using the ‘DeviceN’ colorspace, where absent colorants are generally expected to overprint when overprinting is turned on.

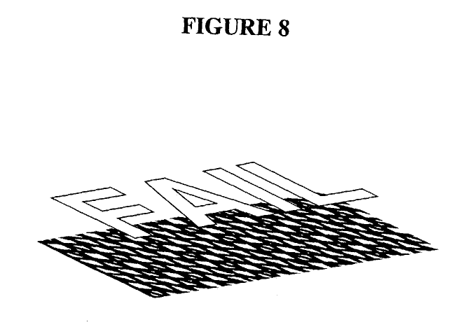

FIG. 8 illustrates the construction of the third patch in the left column. The test patch is composed of a white shape set to overprint a colored layer. Here, the shape is the text “FAIL” in white and the layer is gray formed by a mixture of cyan, magenta and yellow. The white text is set to overprint the gray layer. If properly rendered, the white text should completely disappear instead of knocking out of the gray layer. If it does not overprint then the word “FAIL” will be visible in white on the gray.

The example outputs shown in FIG. 3 and FIG. 4 were obtained using the following description of the preferred test page encoded as an EPS file. The code is converted into PDF by a suitable commercially available PDF creation program (which does not change the overprinting characteristics of the test page code, only its representation). It is designed to test PDF overprinting against the settings specified in ISO 15930-1:2001. It will be apparent to those skilled in the art that this code will produce the effects described above. It will also be apparent that there are variations which can test other overprinting conditions and produce different wording or other visual effects which indicate failures to the viewer of the printed result. It will be further apparent that the result need not necessarily be physically printed but may be rendered on a screen instead either because this is the intended viewing medium, or because it is simulating the printed sheet.

%!PS
%%Title: PDF/X Overprint tests
%%Creator: Global Graphics Software Ltd.
%%Date: 30 Nov 2001
%%BoundingBox: 0 0 130 170
%Copyright Global Graphics Software, Ltd, 2001. All Rights Reserved.
%%EndComments
7 dict begin
/DistOPM<<

/OPM 1

>>def
/setoverprintmode
/setdistillerparams where {

pop

{
//DistOPM dup /OPM 4 −1 roll { 1 }{ 0 }ifelse put
setdistillerparams

}bind

} {

{pop }

}ifelse
def
/box {0 0 50 30 rectfill } bind def
/fail {2 9 moveto (FAIL) show } bind def
/over {60 0 translate } bind def
/down {0 −40 translate } bind def
/Helvetica-Bold 20 selectfont
10 130 translate
% OPM=0 - should knock out
gsave
false setoverprintmode
0 0 0 1 setcmykcolor fail
true setoverprint
.25 .16 .16 0 setcmykcolor box
over
box
grestore
down
% OPM=1 - should overprint
gsave
true setoverprintmode
.85 0 .85 0 setcmykcolor box
true setoverprint
0 .85 0 0 setcmykcolor box
false setoverprint
.85 .85 .85 0 setcmykcolor fail
over
.85 .85 .85 0 setcmykcolor box
grestore
down
% Overprinted white - should be lost
gsave
true setoverprintmode
.85 .85 .85 0 setcmykcolor box
true setoverprint 0 0 0 0 setcmykcolor fail
over
.85 .85 .85 0 setcmykcolor box
grestore
down
% DeviceN - should overprint
gsave
[ /DeviceN [ /Cyan /Yellow] /DeviceCMYK { 0 exch 0 }] setcolorspace
.85 .85 setcolor box
true setoverprint
[ /Separation /Magenta/DeviceCMYK { 0 exch 0 0 }] setcolorspace
0.85 setcolor box
false setoverprint
[ /DeviceN [ /Cyan /Magenta/Yellow ] /DeviceCMYK { 0 }] setcolorspace
.85 .85 .85 setcolor fail
over
.85 .85 .85 0 setcmykcolor box
grestore
end
showpage
%%EOF

What is claimed:

1. A test patch in a palette of colorants comprising:
at least one layer having first values for each colorant and at least one shape having second values for each colorant; and
the test patch is generated according to raster image processing instructions for printing the at least one layer and at least one shape in combination,
the test patch containing a visual confirmation that the raster image processing performed correctly.

2. A test patch comprising:
a colored shape having at least one first colorant with a non-zero value and at least one second colorant with a zero value; and
a colored layer having the at least one first colorant with a zero value and the at least one second colorant with a non-zero value;
the test patch formed in response to an instruction for the colored layer to knockout the colored shape.

3. A test patch comprising:
a first colored layer having at least one colorant with a zero value;
a second colored layer having the at least one colorant with a non-zero value;
a colored shape having the value of the colorant of the first layer for each colorant in the first layer with a non-zero value and the value of the colorant of the second layer for each colorant in the first layer with a zero value;
the test patch formed in response to an instruction for the colored shape to print on the first colored layer and the first colored layer to overprint the second colored layer.

4. The test patch of claim 3 formed in response to the instruction for at least one of (a) the colored shape to overprint the first colored layer or (b) the colored shape to knockout the first colored layer.

5. A test patch comprising a white shape and a colored layer, the test patch formed in response to an instruction for the shape to overprint the layer.

6. The test patch of claim 5 further comprising the white shape having colorants with a zero value.

7. A test patch comprising
a colored shape having at least one first colorant present and at least one second colorant absent; and
a colored layer having the at least one first colorant absent and the second colorant present;
the test patch formed in response to an instruction for the colored layer to knockout the colored shape.

8. A test patch comprising
a first colored layer having at least one colorant absent;
a second colored layer having the at least one colorant present;
a colored shape having the value of the colorant of the first layer for each colorant present in the first layer and the value of the colorant of the second layer for each colorant absent in the first layer;
the test patch formed in response to an instruction for the colored shape to print on the first colored layer and the first colored layer to overprint the second colored layer.

9. A test page comprising at least one of:
(a) a first patch formed in response to an instruction for a colored layer to knockout a different colored shape, and a first canonical patch in the color corresponding to the first patch;
(b) a second patch formed in response to an instruction for a composite colored shape to print on a first colored layer and for the first colored layer to overprint a second colored layer, and a second canonical patch in the composite color corresponding to the second patch; or
(c) a third patch formed in response to an instruction for a white shape to overprint a third colored layer, and a third canonical patch in the third color corresponding to the third patch.

10. A test for determining if a test patch produced by raster image processing is correct comprising:
a test patch rendered from the combination of at least one shape and at least one layer; and
a canonical patch produced from a layer having the colorants that would result if the test patch was correctly rasterized.

11. A method for determining if a test patch produced by raster image processing is correct, comprising the steps of:
printing the test patch rendered from a combination of at least one shape and at least one first layer using the raster image processing; and
determining whether the test patch was correctly rasterized based on a visual indication on the test patch.

12. The method of claim 11 further comprising the steps of:
defining a colored shape having at least one first colorant with a non-zero value and at least one second colorant with a zero value; and
defining a colored layer having the at least one first colorant with a zero value and the second colorant with a non-zero value; and
instructing the colored layer to knockout the colored shape.

13. The method of claim 11 further comprising the steps of:
defining a first colored layer having at least one colorant with a zero value;
defining a second colored layer having the at least one colorant with a non-zero value;
defining a colored shape having the value of the colorant of the first layer for each colorant in the first layer with a non-zero value and the value of the colorant of the second layer for each colorant in the first layer with a zero value;
instructing the colored shape to knockout the first colored layer and the first colored layer to overprint the second colored layer.

14. The method of claim 11 further comprising the steps of:
defining a first colored layer having at least one colorant with a zero value;
defining a second colored layer having the at least one colorant with a non-zero value;
defining a colored shape having the value of the colorant of the first layer for each colorant in the first layer with a non-zero value and the value of the colorant of the second layer for each colorant in the first layer with a zero value;
instructing the colored shape to overprint the first colored layer and the first colored layer to overprint the second colored layer.

15. A method of claim 11 further comprising the steps of: defining a white shape; defining a colored layer; and instructing the shape to overprint the layer.

16. The method of claim 15 further comprising the step of defining the shape with zero value for each colorant.

17. The method of claim 11 further comprising the steps of:
defining a first colored layer having at least one colorant absent;
defining a second colored layer having the at least one colorant present;
defining a colored shape having the value of the colorant of the first layer for each colorant present in the first layer and the value of the colorant of the second layer for each colorant absent in the first layer;
instructing the colored shape to print on the first colored layer and the first colored layer to overprint the second colored layer.

18. The method of claim 11 further comprising the step of determining that the test failed when the shape is visible in the rendered test patch.

19. The method of claim 18 wherein the shape is in the form of the text “fail” “Fail” or “FAIL.”

20. The method of claim 11 wherein the shape is associated with a feature of raster imager processing subject to the test.

21. The method of claim 11 wherein the shape is associated with a corrective feature appropriate in the event of test failure.

22. The method of testing the results of raster imager processing comprising the steps of printing a test patch formed in response to an instruction for a combination of at least one shape and at least one layer; and printing a canonical patch of a predetermined color that would result if the test patch is correctly rasterized.

23. The method of claim 22 further comprising the step of comparing the test patch to the canonical patch to determine if they are the same.

24. The method of claim 22 further comprising the step of determining that the test failed when the color of the test patch is different from the predetermined color of the canonical patch.

25. The method of claim 22 further comprising the step of determining that the test succeeded when the color of the test patch is the same as the predetermined color of the canonical patch.

26. The method of claim 22 wherein the canonical patch is printed adjacent to the test patch.
